(19) United States
(12) Patent Application Publication
(10) Pub. No.: US 2025/0261629 A1
(43) Pub. Date: Aug. 21, 2025

(54) Pest Repellant System

(71) Applicant: Symterra, Inc., Tucson, AZ (US)

(72) Inventors: John Smalley, Tucson, AZ (US); David Rogers, Tucson, AZ (US)

(21) Appl. No.: 19/029,034

(22) Filed: Jan. 17, 2025

Related U.S. Application Data
(63) Continuation of application No. PCT/US23/28272, filed on Jul. 20, 2023.
(60) Provisional application No. 63/390,884, filed on Jul. 20, 2022.

(51) Int. Cl. A01M 29/26

(52) U.S. Cl. CPC A01M 29/26

(57) ABSTRACT

The present disclosure provides a bird repellant system that includes pulse generator circuitry to generate a plurality of pulses from a power source. The system also includes variable frequency controller circuitry to control a frequency of the plurality of pulses, wherein the variable frequency controller to control the frequency of the plurality of pulses so that a selected bird species is repelled. The system also includes an electromagnetic emitter to receive to plurality of pulses and to generate a pulsed electromagnetic signal having frequency based on the frequency of the plurality of pulses, wherein the pulsed electromagnetic signal operates to repel the selected bird species.

This application is a Continuation of PCT/US23/28272, filed Jul. 20, 2023, which claims the benefit of U.S. Provisional Application Ser. No. 63/390,884, filed Jul. 20, 2022, both of which are hereby incorporated by reference in their entirety.

### TECHNICAL FIELD

The present disclosure relates to pest repellant systems, and, more particularly, to electromagnetic field pest repellent systems with variable frequency and voltage control.

### BACKGROUND

Bird pest management is a significant problem in a wide variety of commercial, municipal and military concerns. Several products exist on the market for bird abatement and control, for example, spikes, roof coatings, high frequency sonic generators, etc., however, none of the currently available bird abatement approaches provide a lasting and consistent deterrence for birds to land and/or nest in unwanted areas. Birds are known to be disease carriers, and are known to cause significant damage to structures (e.g., buildings, billboards, farm and livestock areas, etc.). Thus, workers assigned for bird cleanup and bird damage repair are often exposed to toxic work environments, and are also often exposed to hazardous work environments from the corrosive effects of bird droppings and urine, the build-up of bird droppings and urine, etc.

As is known for particular bird species of pigeons (members of Columbidae family), low power electromagnetic pulses of a particular frequency (approximately 120 Hz) can interfere with birds' ability to navigate. Such electromagnetic pulses can be used to deter and repel birds from landing and/or nesting on or near structures or areas, for example, buildings, billboards, farm and livestock shelters, airport and airfield areas, etc. However, it is not known in the art the particular frequency needed to deter other varieties of bird species. In addition, it is not known in the art a signal strength needed to deter varieties of bird species. In addition, for pigeon deterrence using pulsed electromagnetic signals at approximately 120 Hz, it is not known if pigeons will eventually adapt to that frequency and return to land and/or nest in unwanted areas.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates a pest repellent system according to several embodiments of the present disclosure;

FIG. 2 illustrates a pest repellant system according to one embodiment of the present disclosure;

FIG. 3 illustrates a pest repellant system according to another embodiment of the present disclosure; and

FIG. 4 illustrates a pest repellant system according to another embodiment of the present disclosure.

Although the following Detailed Description will proceed with reference being made to illustrative embodiments, many alternatives, modifications and variations thereof will be apparent to those skilled in the art.

### DETAILED DESCRIPTION

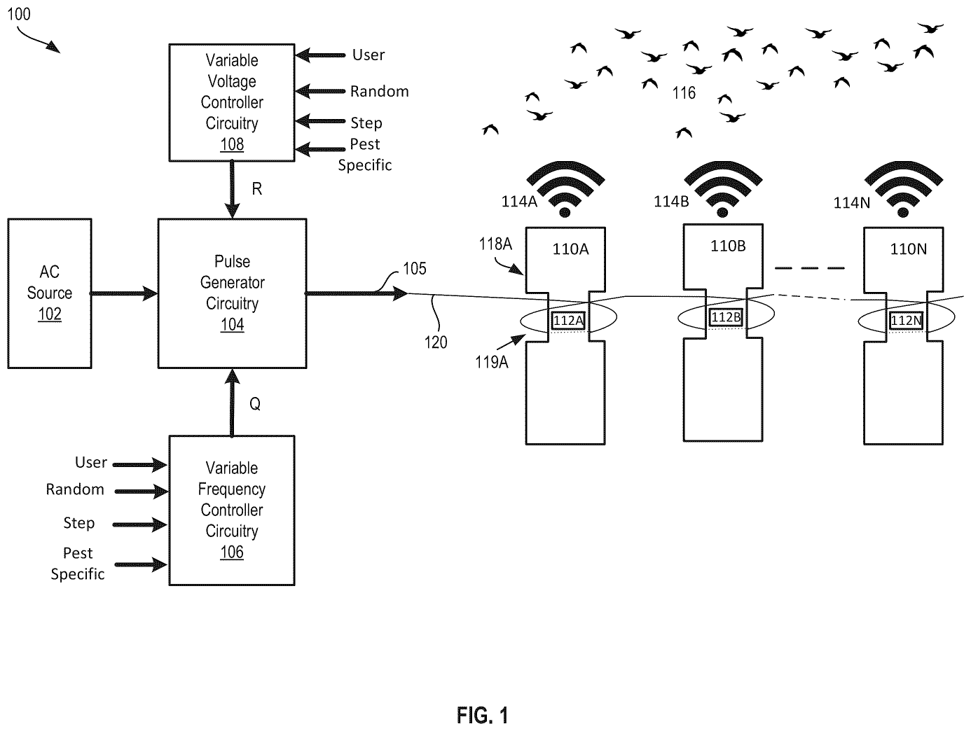

FIG. 1 illustrates a pest repellant system 100 according to several embodiments of the present disclosure. While the following description is in reference to a pet repellent system specific to birds (and, more specifically, to pigeon species), the teachings of the present disclosure may be applied to different kinds of pests, including, for example, avian pests (birds, bats, flying insects (e.g., bees, wasps, hornets, etc.) and/or ground pests including, for example, rodents, insects, etc. As a general matter, the teachings of the present disclosure may apply to any pest species that uses innate navigational abilities. The system 100 includes pulse generation circuitry 104 generally configured to generate a frequency-controlled and/or voltage-controlled pulse train 105 from a power source, for example an AC power AC power source 102. The AC power source 102 may include conventional residential and/or commercial AC power, for example, 110/120 V. AC at 60 Hz, 220 V. AC at 60 Hz, 480 V. AC at 60 Hz, and/or other conventional and/or proprietary AC power source. The following description will be in reference to a conventional 110/120 V. AC power source operating at 60 Hz, however the teachings of the present disclosure can be applied to any AC power source.

The system 100 also includes one or more emitters 110A, 110B, . . . , 110N generally configured to generate a respective pulsed electromagnetic signal 114A, 114B, . . . , 114N in response to the pulse signal train 105. The emitters 110A, 110B, . . . , 110N may be placed on or near structures, for example, billboards, rooftops, etc., and/or on or near specified areas, for example, fields, entryways, private/commercial/military airfield facilities, etc., so that the pulsed electromagnetic field signal 114A, 114B, . . . , 114N repel birds away from those structure/areas, as generally illustrated by the flock of birds 116 moving away from the emitters 110A, 110B, . . . , 110N in response to the presence of the pulsed electromagnetic field signals 114A, 114B, . . . , 114N. The number of emitters 110A, 110B, . . . , 110N may be selected for a given operating environment and/or to provide coverage for a selected area, such that a sufficient number of emitters 110A, 110B, . . . , 110N are selected to generate a sufficient field strength to avoid coverage gaps, thus preventing birds to land/nest in unwanted areas. For example, to deter pigeons from landing/nesting on a billboard structure, the emitters 110A, 110B, . . . , 110N may be spaced approximately 3-10 feet apart along the base or catwalk of a billboard. As another example, to deter pigeons form landing/nesting on a rooftop of a building or other structure the emitters 110A, 110B, . . . , 110N may be spaced approximately 3-10 feet apart along the peak and/or periphery of the rooftop.

The emitters 110A, 110B, . . . , 110N are illustrated in cross section in FIG. 1. Using emitter 110A as an example, the emitter generally includes an insulative body 118A and a metallic disk 112A disposed within the insulative body 118A. The insulative body 118A may be formed of any suitable non-conductive material such as plastic, polyethylene, silicon, etc. and such material may be selected to have a desired hardness and/or weather resistance and/or UV resistance for a given operating environment. The insulative body 118A may also include a notch 119A extending around the body. The metallic disk 112A may be disposed within the body 118A and positioned adjacent the notch 119A, as illustrated. The metallic disk 112A may be formed of any ferrous metal, for example, steel, iron, etc.

The system 100 also includes a conductive wire 120 coupled to the pulse generator circuitry 108 and to the emitters 110A, 110B, . . . , 110N. The conductive wire 120 is selected to have sufficient strength, depending on the length needed to reach all of the emitters 110A, 110B, . . . , 110N from the pulse generator circuitry 108, and sufficient diameter to properly conduct relatively high voltages (e.g., 1 kVAC-4 kVAC) of the pulse signal train 105 without significant resistance. In some example embodiments, and again using emitter 110A as an example, the conductive wire 120 is looped around the body 118A and disposed within the notch 119A, i.e., so that the loop of conductive wire 120 surrounds, at least in part, the metallic disk 112A disposed within the body 118A. The metallic disk 112A, in response to the pulses 105 in the wire 120, operates in capacitive and inductive fashion to generate the pulsed electromagnetic signal 114A. The emitters 110B, . . . 110N may be similarly constructed and operate in a similar manner as emitter 110A, described above.

The system of FIG. 1 also includes variable frequency controller circuitry 106 generally configured to control the pulse generator circuitry 104 to generate a pulse signal 105 having a user-selectable and/or random frequency. In one example embodiment, the variable frequency controller circuitry 106 may generate a frequency multiplier (Q) based on a user-specified frequency of operation (“User”). As a general matter, the pulse generator circuitry 104 is configured to apply Q to the frequency of the AC signal received from the AC source 102, so that the frequency of the signal pulses 105 is changed by a factor of Q. Controlling the frequency of the pulse signals 105 also controls the frequency of the pulsed electromagnetic field signals 114A, 114B, . . . , 114N. In some example embodiments, the value of Q may be selected to be between 0.05 and 4, thus multiplying the frequency value of the AC source 102 by 0.5 to 4. A user may select Q based on, for example the frequency of the AC source 102, a desired/target frequency of operations, etc. To that end, a target frequency of operation may be pet-specific, i.e., a frequency may be selected to interrupt/disrupt an innate navigation ability of a particular pest species.

In another example embodiment, the variable frequency controller circuitry 106 may generate a frequency multiplier (Q) based on a pest specific frequency of operation (“Pest Specific”). For example, as described above, it is known that electromagnetic pulses of approximately 120 Hz can affect certain pigeon species ad deter these certain pigeon species away from the signal source. However, other pigeon species, and/or other bird species and/or other pest species, may require an operating frequency other than 120 Hz to be a deterrence. Accordingly, the pest specific frequency of operation enables the variable frequency controller 106 to be “tuned” to a specific bird type and/or bird species type and/or pest species type, thus enhancing the pest repellent ability of the system 100. By selecting a frequency (or frequency range) for a specific pest type, the teachings of the present disclosure may offer enhanced pest deterrence for targeted pest while avoiding interference with other animals.

In another example embodiment, the variable frequency controller circuitry 106 may generate a variable frequency multiplier (Q) so that the frequency of operation randomly varies within a selected frequency range (“Random”). For example, and again using the pigeon example, while the specific frequency to deter some pigeon species is known to be approximately 120 Hz, deterrence of these pigeon species may occur in a frequency range of between 80 Hz to 150 Hz. Thus, the variable frequency controller circuitry 106 may generate a variable and random frequency multiplier (Q) to cause the pulse generator circuitry 104 to generate the pulse signals 105 having a random frequency within the range of 80 Hz to 150 Hz. Of course, this is only an example of the range of frequency operations, and in other embodiments other frequency ranges may be selected and the variable frequency multiplier (Q) may be applied in those other frequency ranges. Moreover, in some embodiments, the variable and random frequency multiplier (Q) may be generated by the variable frequency generator 106 at fixed and/or random intervals (timing). For example, the variable and random multiplier (Q) may be generated at user-defined intervals (e.g., every 5 seconds, etc.) or at random intervals within a user-definable range (e.g., 1-20 seconds). It will be appreciated that some bird species may adapt to a fixed operating frequency, thus enabling the birds to land/nest in unwanted areas despite the presence of the pulsed electromagnetic signals 114A, 114B, . . . , 114N. By providing randomness in both frequency and timing, birds may not be able to adapt to such conditions and instead permanently seek other areas to land/nest.

In still another example embodiment, the variable frequency controller circuitry 106 may generate a variable frequency multiplier (Q) so that the frequency of operation incrementally changes within a selected frequency range (“Step”). For example, and again using the pigeon example, while the specific frequency to deter some pigeon species is known to be approximately 120 Hz, deterrence of these pigeon species may occur in a frequency range of between 80 Hz to 150 Hz. Thus, the variable frequency controller circuitry 106 may generate a variable and random frequency multiplier (Q) to cause the pulse generator circuitry 104 to generate the pulse signals 105 having a selected value within the range of 80 Hz to 150 Hz. For example, a step value of 2 may be selected so that the pulse signals 105 takes on frequencies values incremented and/or decremented by 2 Hz (resulting in increments of 80 Hz, 82 Hz, 84 Hz, and so on). Of course, this is only an example of a step value and range of frequency operations, and in other embodiments other step values and frequency ranges may be selected and the variable frequency multiplier (Q) may be applied in those other frequency ranges. Moreover, in some embodiments, the stepped frequency multiplier (Q) may be generated by the variable frequency generator 106 at fixed and/or random intervals (timing). For example, the stepped multiplier (Q) may be generated at user-defined intervals (e.g., every 5 seconds, etc.) or at random intervals within a user-definable range (e.g., 1-20 seconds). It will be appreciated that some bird species may adapt to a fixed operating frequency, thus enabling the birds to land/nest in unwanted areas despite the presence of the pulsed electromagnetic signals 114A, 114B, . . . , 114N. By providing stepped frequency values at selected intervals, birds may not be able to adapt to such conditions and instead permanently seek other areas to land/nest.

The system of FIG. 1 also includes variable voltage controller circuitry 108 generally configured to control the pulse generator circuitry 104 to generate the pulse signals 105 having a user-selectable and/or random voltage. In one example embodiment, the variable voltage controller circuitry 108 may generate a voltage multiplier (R) based on a user-specified frequency of operation (“User”). As a general matter, the pulse generator circuitry 104 is configured to apply R to the amplitude of the AC signal received from the AC source 102, so that the amplitude of the signal pulses 105 is changed by a factor of R. Controlling the voltage of the pulse signals 105 also controls the signal strength of the pulsed electromagnetic field signals 114A, 114B, . . . , 114N. In some example embodiments, the value of R may be selected to be between 9 and 40, thus multiplying the amplitude value of the AC source 102 by 9 to 40, thus generating pulses 105 in the range of 1 kV AC to 4 KV AC. A user may select R based on, for example, the amplitude of the AC source 102, a desired/target amplitude of operations, etc.

In another example embodiment, the variable voltage controller circuitry 108 may generate a voltage multiplier (R) based on a pest specific frequency of operation (“Pest Specific”). For example, pulse signals 105 having voltage (amplitude) value of between 1 kV and 4 kV can generate electromagnetic pulses of sufficient strength to deter certain pigeon species away from the signal source. However, other pigeon species, and indeed other bird species, may require a signal strength that is specific within this range and/or greater than (or less than) 1 kV-4 kV to be a deterrence. Accordingly, the pest specific frequency of operation enables the variable frequency controller 106 to be “tuned” to a specific pest type, thus enhancing the pest repellent ability of the system 100. By selecting a voltage (or voltage range) for a specific pest type, the teachings of the present disclosure may offer enhanced pest deterrence for targeted pests, while avoiding interference with other animals.

In another example embodiment, the variable voltage controller circuitry 108 may generate a variable voltage multiplier (R) so that the voltage of operation randomly varies within a selected voltage range (“Random”). For example, and again using the pigeon example, while the specific voltage to deter some pigeon species is known to be in the range of 1 kV to 4 kV, deterrence of these pigeon species may occur by varying the voltage within this range. Thus, the variable voltage controller circuitry 108 may generate a variable and random voltage multiplier (R) to cause the pulse generator circuitry 104 to generate the pulse signals 105 having a random voltage within the range of 1 kV to 4 kV. Of course, this is only an example of the range of voltage operations, and in other embodiments other voltage ranges may be selected and the variable voltage multiplier (R) may be applied in those other voltage ranges. Moreover, in some embodiments, the variable and random voltage multiplier (R) may be generated by the variable voltage controller circuitry 108 at fixed and/or random intervals (timing). For example, the variable and random multiplier (R) may be generated at user-defined intervals (e.g., every 5 seconds, etc.) or at random intervals within a user-definable range (e.g., 1-20 seconds). It will be appreciated that some bird species may adapt to a fixed operating voltage, thus enabling the birds to land/nest in unwanted areas despite the presence of the pulsed electromagnetic signals 114A, 114B, . . . , 114N. By providing randomness in both voltage and timing, birds may not be able to adapt to such conditions and instead permanently seek other areas to land/nest.

In still another example embodiment, the variable voltage controller circuitry 108 may generate a variable voltage multiplier (R) so that the voltage of operation incrementally changes within a selected frequency range (“Step”). Thus, for example, the variable voltage controller circuitry 108 may generate a variable and random frequency multiplier (Q) to cause the pulse generator circuitry 104 to generate the pulse signals 105 having a selected value within the range of 1 kV to 4 kV. For example, a step value of 10 may be selected so that the pulse signals 105 takes on voltage values incremented and/or decremented by 10 V (resulting in increments of 1 kV, 1010 V, 1020 V, and so on). Of course, this is only an example of a step value and range of voltage operations, and in other embodiments other step values and voltage ranges may be selected and the variable voltage multiplier (R) may be applied in those other voltage ranges. Moreover, in some embodiments, the stepped voltage multiplier (R) may be generated by the variable voltage generator 108 at fixed and/or random intervals (timing). For example, the stepped multiplier (R) may be generated at user-defined intervals (e.g., every 5 seconds, etc.) or at random intervals within a user-definable range (e.g., 1-20 seconds). It will be appreciated that some bird species may adapt to a fixed operating voltage, thus enabling the birds to land/nest in unwanted areas despite the presence of the pulsed electromagnetic signals 114A, 114B, . . . , 114N. By providing stepped voltage values at selected and./or random intervals, birds may not be able to adapt to such conditions and instead permanently seek other areas to land/nest.

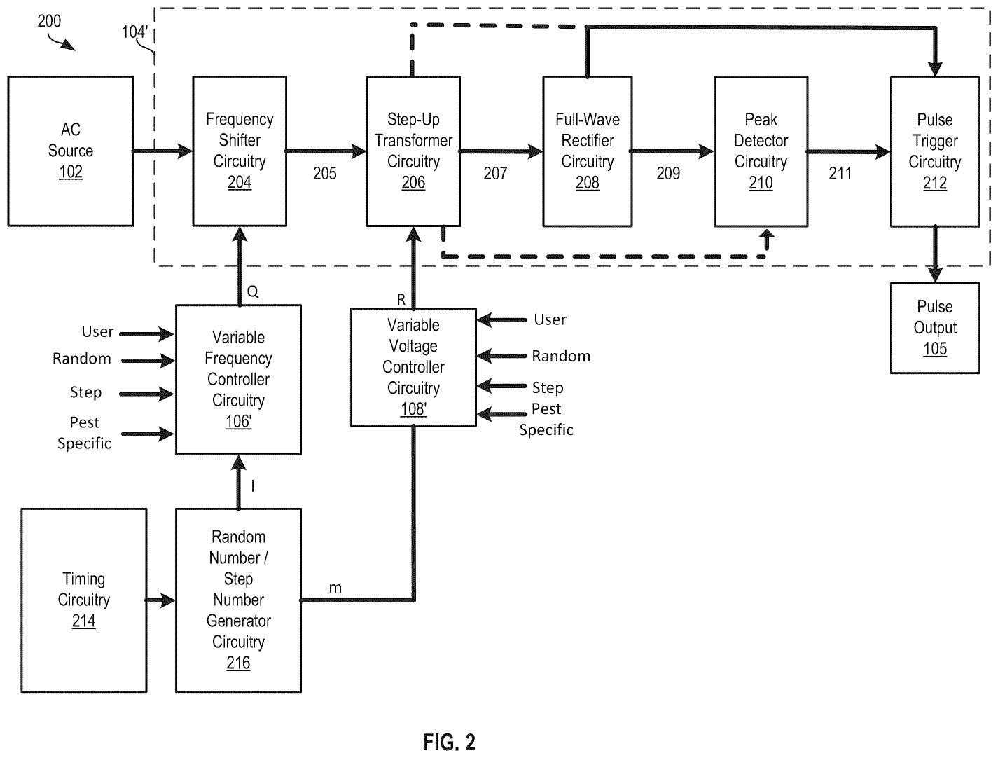

FIG. 2 illustrates a pest repellant system 200 according to one embodiment of the present disclosure. In this embodiment, the pulse generator circuitry 104′ includes frequency shifter circuitry 204 generally configured to generate a frequency-controlled AC power source 205 from the AC power source 102. Frequency shifter circuitry 204 is configured to shift the frequency of the AC power source 102 by a user-specified and/or programmable and/or random frequency shift amount, as described above. In some example embodiments, the frequency shifter circuitry 204 is configured to apply the frequency multiplier (Q) to the AC power source 102 to generate a frequency-controlled AC power source, for example, having a frequency value of Q*60 Hz; where 0.5<Q<4. Thus, in this example, the frequency-controlled AC power source 205 can have a frequency in the range of 30 Hz to 240 Hz. Of course, this is only an example range of frequency shifting, and in other embodiments R can be less than 0.5 and/or greater than 4. The value of Q may be generated by the variable frequency controller circuitry 106′, described above.

The system 200 also includes step-up transformer circuitry 206 generally configured to generate a stepped-up AC power source 207 from the frequency-controlled AC power source 205. In some embodiments, the step-up transformer circuitry 206 includes a primary and secondary coils having a winding ratio to generate a stepped up AC power source 207 in the range of 1 kV AC-4 kV AC. In some embodiments, the transformer circuitry 206 may include variable voltage output circuitry (e.g., multi-tap transformer circuitry, etc.) to enable a user-specified and/or programmable and/or random voltage output, as described above. The system 200 may also include full-wave rectifier circuitry 208 to generate a full wave rectified AC power source 209 from the stepped-up AC power source 207. In some embodiments, the full wave rectifier circuitry 208 may include known and/or proprietary circuitry, for example, diode bridge circuitry, to invert a negative half cycle of the stepped-up AC power source 207. As can be appreciated, the full wave rectified AC power source 209 has the effect of doubling the frequency of the stepped-up AC power source 207 in that each positive lobe of the full wave rectified AC power source 209 represent a half cycle of the frequency.

The system 200 also includes peak detector circuitry 210 generally configured to generate a peak detection signal 211 based on a peak voltage of an AC power source. In one embodiment, the peak detection circuitry 210 is configured to generate a peak detection signal 211 based on the full wave rectified AC power source 209. In another embodiment, the peak detection circuitry 210 is configured to generate a peak detection signal 211 based on the stepped-up AC power source 207. In either case, the peak detection signal 211 may have a frequency and amplitude corresponding to (or proportional to) the peak of the AC signal. The system 200 also includes pulse trigger circuitry 212 generally configured to generate the pulse signals 105 based on the peak detection signal 211. In one embodiment, the pulse trigger circuitry 212 is configured to generate the pulse signals 105 based on the full wave rectified AC power source 209. In another embodiment, the peak trigger circuitry 212 is configured to generate the pulse signals based on the stepped-up AC power source 207. In either case, the pulse trigger circuitry momentarily pulses the AC power based on the peak detection signal 211, thus the pulse signals 105 have a frequency and amplitude corresponding to the received AC power.

The system 200 of FIG. 2 also includes random number and/or step number generation circuitry 216 to supply the variable frequency controller circuitry 106′ and the variable voltage controller circuitry 108′ with a selected and/or predetermined random variable l and m, respectively. This enables the random frequency and voltage operations described above. In addition, the system 200 may also include timing circuitry 214 to enable the timing intervals of the random and/or stepped voltage and frequency operations, described above.

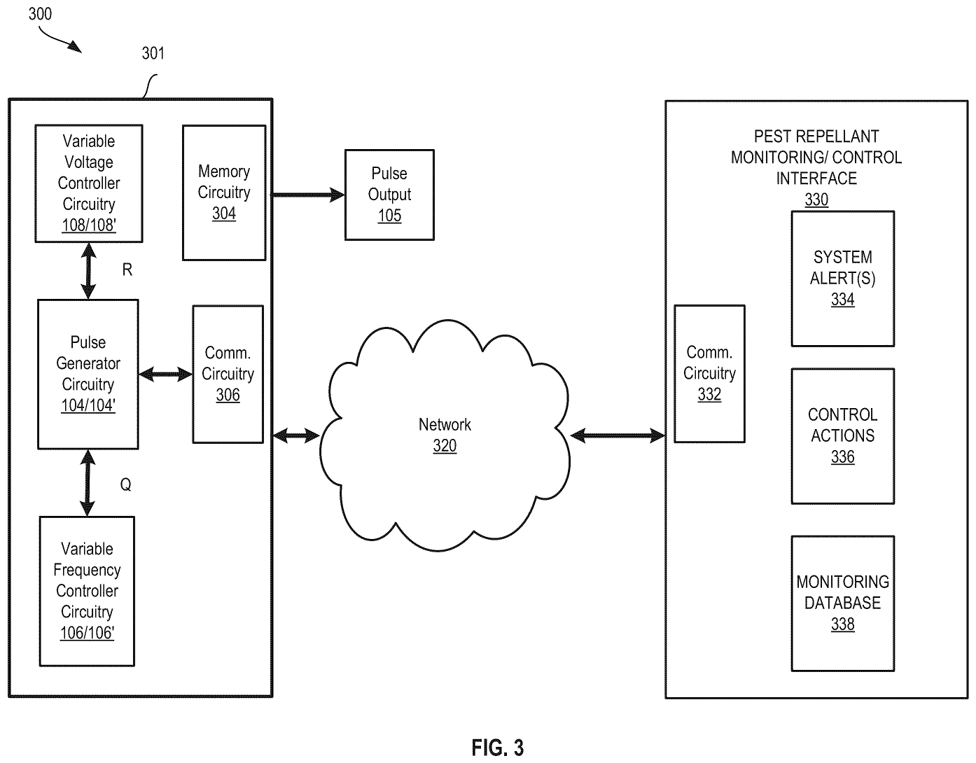

FIG. 3 illustrates a pest repellant system 300 according to another embodiment of the present disclosure. In this embodiment, the pulse generator circuitry 104 and/or 104′, variable frequency controller circuitry 106 and/or 106′, variable voltage controller circuitry 108 and/or 108′ memory circuitry 302 and communications circuitry 306 may be disposed within a housing structure 301 (also referred to as “pulse generator system 301”). The housing structure 301 may be formed of metal, plastic, composite materials, etc., and may be formed to provide sufficient structural integrity and tamper resistance for a given site installation. The pulse generator system 301 is generally configured to generate the voltage and/or frequency controlled pulses (105), as described above. The pulse generator system 301 of this embodiment includes communication circuitry 306 generally configured to exchange commands and data with a remote system (described below), via network 320. The communications circuitry 306 may communicate using a known and/or after-developed communications protocols including, for example, cellular communications protocols (e.g., LTE, 3G, 4G, 5G/6G, etc.), wireless network communications protocols (e.g., IEEE 10 BASE x, WiFi, etc.), etc. In some embodiments, for example, if the system 300 is deployed in a remote location outside of cellular/wifi coverage, communications circuitry 306 may be configured to communicate using satellite communications protocols, etc. Communications circuitry 306 may also include antennae systems (e.g., direction and/or polar antennae arrays, etc.) and/or signal boosting circuitry (not shown) to enable greater range of communications.

The pulse generator system 301 may also include memory circuitry 304 to store historical data concerning the state and status of various components (e.g., power status, operating voltage, operating frequency, system alert messages, component status messages, time/date stamp data, etc.), which may be transmitted to the remote interface 330 on a continuous and/or periodic basis to enable remote monitoring and control of over various components of the pulse generating system 301.

The system 300 may also include a remote pest repellant monitoring/control interface 330 generally configured to exchange commands and data with the pulse generating system 301, receive messages and alerts from the pulse generating system 301, and to control various operational aspects of the pulse generating system 301. In some embodiments, the interface 330 may be embodied as a smart phone device (e.g., iPhone, Galaxy, etc.) and/or smart tablet device (e.g., iPad, laptop computer, etc.), etc., that includes a display, communications circuitry, input circuitry (e.g., touch screen, keyboard, etc.). The interface 330 may include executable instructions and/or instruction sets, for example, in the form of an “app” or application, to perform the various task described herein. The interface may include communications circuitry 332 (similar in functionality to communications circuitry 306, described above) to exchange commands and data with the pulse generating system 301, via network 320.

The interface 330 may include system alert(s) code 334 generally configured to trigger an alert upon receipt of an alert message from the pulse generating system 301. Examples of alert messages include available power, voltage and frequency operational modes, power failure alert message, component status messages, time/date stamp data, etc. The alert may include, for example, flashing lights, defined sound, vibration, generation of a text and/or email message, etc, so that a user is notified of the alert message. The interface 330 may also include control actions code 336 to generate one or more control commands to control various components of the pulse generating system 301. Control commands may include, for example, setting frequency of the variable frequency controller circuitry 106/106′, setting a voltage of the variable voltage controller circuitry 108/108′, retrieving historical data from memory 304, adjusting other settings or parameters of the pulse generating system 301, etc. The interface 330 may also include a monitoring database 338 to store historical data concerning the various parameters and operational status of components of the pulse generating system 301.

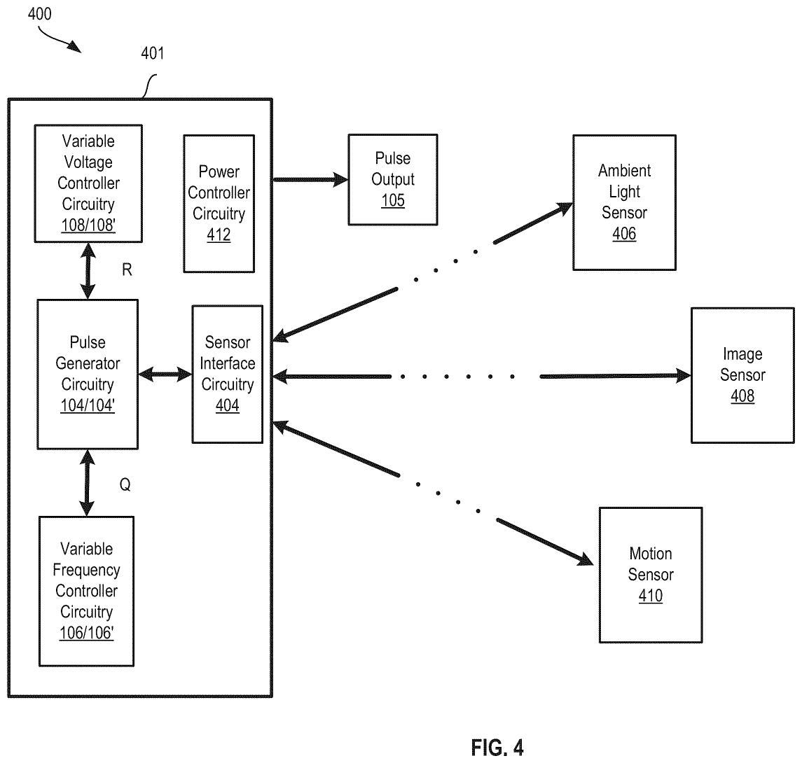

FIG. 4 illustrates a pest repellant system 400 according to another embodiment of the present disclosure. In this embodiment, the pulse generator circuitry 104 and/or 104′, variable frequency controller circuitry 106 and/or 106′, variable voltage controller circuitry 108 and/or 108′ power controller circuitry 412 and sensor interface circuity 404. circuitry 302 and communications circuitry 306 may be disposed within a housing structure 301 (also referred to as “pulse generator system 401”). The housing structure 301 may be formed of metal, plastic, composite materials, etc., and may be formed to provide sufficient structural integrity and tamper resistance for a given site installation. The pulse generator system 401 is generally configured to generate the voltage and/or frequency controlled pulses (105), as described above. The pulse generator system 401 of this embodiment includes power controller circuitry 412 generally configured to control a power state of the pulse generator circuitry 104 and/or 104′, variable frequency controller circuitry 106 and/or 106′ and/or variable voltage controller circuitry 108 and/or 108′ based on a preselected power protocol and/or sensor information (described below). The preselected power protocol may include, for example powering the pulse generator circuitry 104 and/or 104′, variable frequency controller circuitry 106 and/or 106′, variable voltage controller circuitry 108 and/or 108′ on or off at certain times of the day, powering the pulse generator circuitry 104 and/or 104′, variable frequency controller circuitry 106 and/or 106′, variable voltage controller circuitry 108 and/or 108′ at preselected intervals, low power mode operations, etc.

The pulse generator system 401 of this embodiment includes sensor interface circuitry 404 to receive sensor data from and/or control one or more sensors. The system 400 may include, for example, one or more ambient light sensor(s) 406 generally configured to generate a signal indicative of ambient light conditions (e.g., daylight, night, reduce daylight (cloudy), etc.). The system 400 may also include one or more image sensor(s) 408 generally configured to generate image data (e.g., still image data, video image data, color image data, black and white image data, infrared image data, etc.). The system 400 may also include one or more motion sensor(s) 410 generally configured to generate a signal indicative of motion (e.g., motion of a pest, etc.) within the vicinity of the sensor(s) 410.

In some embodiments, the sensor data may be used by the pulse generator circuitry 104/104′ and/or power controller circuitry 412 to control the state, frequency and/or voltage of the generated pulses 105. For example, certain pest species may be known to be inactive at night. The ambient light sensor(s) 406 may generate a signal indicating nigh time hours. In response, the power controller circuitry 412 may control the pulse generator circuitry 104/104′ to an off state or standby state (reduced power mode). In addition, it is known that some pest species become particularly active at dusk, as the pest species attempts to find a place to roost/nest/sleep for the night. The pulse generator circuitry 104/104′, in response to data from the ambient light sensor 406 indicating a dusk condition, may control the variable voltage/frequency of the pulses to increase the electromagnetic fields generated by the pulses 105 to deter pests from landing near the emitters.

As another example, the image sensor 408 may be used to determine active/inactive periods of a target pest species, and may also be used to control the pulse generator circuitry 104/104′ to an off state or standby state (reduced power mode) if no pests are detected in the image data, or turn the pulse generator circuitry 104/104′ on in the presence of a pest species in the image data. Similarly, the motion sensor 410 may be used to determine active/inactive periods of a target pest species, and may also be used to control the pulse generator circuitry 104/104′ to an off state or standby state (reduced power mode) if no motion is detected in the vicinity of the sensor 410, or turn the pulse generator circuitry 104/104′ on when motion is detected.

In some embodiments, the pulse generator system 401 may be configured to control the sensors 406, 408, and/or 410. For example, the pulse generator system 401 may be configured to control an on/off state of the sensors 406, 408, and/or 410. As another example, the pulse generator system 401 may be configured to control the image sensor(s) 408, for example, for focus, position, etc.

It should be understood that some embodiments of the present disclosure may include a combination of one or more components described with reference to FIGS. 1-4.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Any of the operations described herein may be implemented in a system that includes one or more non-transitory storage devices having stored therein, individually or in combination, instructions that when executed by circuitry perform the operations. “Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including hardware embodiments of accelerators such as neural net processors and non-silicon implementations of the above. The circuitry may, collectively or individually, be embodied as components that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

1. A pest repellant system, comprising:
pulse generator circuitry to generate a plurality of pulses from power source;
variable frequency controller circuitry to control a frequency of the plurality of pulses, wherein the variable frequency controller to control the frequency of the plurality based on a selected species of pest; and wherein the pulse generator circuitry to generate, for at least some of the pulses in the plurality of pulses, pulse signals having a random frequency within the range of 80 Hertz to 150 Hertz.

2. The system of claim 1, further comprising: an electromagnetic emitter to receive the plurality of pulses and to generate a pulsed electromagnetic signal having frequency based on the frequency of the plurality of pulses, wherein the frequency of the pulsed electromagnetic signal operates to repel the selected pest species.

3. The system of claim 1, further comprising: variable voltage controller circuitry to control a voltage of the plurality of pulses, wherein the variable voltage controller to control the voltage of the plurality of pulses based on the selected species of pest.

4. The system of claim 3, wherein the variable voltage controller circuitry configured to randomly select, for at least some of the pulses in the plurality of pulses, a voltage within a predefined range.

5. The system of claim 3, wherein the variable voltage controller circuitry configured to select, for at least some of the pulses in the plurality of pulses, a stepped-up voltage level within a predefined range.

6. The system of claim 3, wherein the variable voltage controller circuitry configured to provide a user to select, for at least some of the pulses in the plurality of pulses, a voltage within a predefined range.

7. (canceled)

8. (canceled)

9. The system of claim 1, wherein the variable frequency controller circuitry configured to select, for at least some of the pulses in the plurality of pulses, a stepped-up frequency level within a predefined range.

10. The system of claim 1, wherein the variable frequency controller circuitry configured to provide a user to select, for at least some of the pulses in the plurality of pulses, a frequency within a predefined range.

11. (canceled)

12. The system of claim 1, further comprising: communications circuitry to exchange commands and data with a remote interface system.

13. (canceled)

14. The system of claim 1, further comprising:
one or more sensors selected from the group of an ambient light sensor to detect daylight, an image sensor to generate a still or video image, and/or a motion sensor to detect the presence of a pest based on motion; and
sensor interface circuitry to receive sensor data from the one or more sensors; wherein the pulse generator circuitry to control generation of the plurality of pulses based on, at least in part, the sensor data.

15. A pest repellant system, comprising:
pulse generator circuitry to generate a plurality of pulses from power source;
variable voltage controller circuitry to control a voltage of the plurality of pulses, wherein the variable voltage controller to control the voltage of the plurality of pulses based on a selected species of pest; and
variable frequency controller circuitry to control a frequency of the plurality of pulses. wherein the variable frequency controller to control the frequency of the plurality based on a selected species of pest; and wherein the pulse generator circuitry to generate, for at least some of the pulses in the plurality of pulses, pulse signals having a random frequency within the range of 80 Hertz to 150 Hertz.

16. The system of claim 15, further comprising: an electromagnetic emitter to receive the plurality of pulses and to generate a pulsed electromagnetic signal having signal strength based on the voltage of the plurality of pulses, wherein the voltage of the pulsed electromagnetic signal operates to repel the selected pest species.

17. (canceled)

18. (canceled)

19. The system of claim 17, wherein the variable frequency controller circuitry configured to select, for at least some of the pulses in the plurality of pulses, a stepped-up frequency level within a predefined range.

20. The system of claim 17, wherein the variable frequency controller circuitry configured to provide a user to select, for at least some of the pulses in the plurality of pulses, a frequency within a predefined range.

21. (canceled)

22. The system of claim 15, wherein the variable voltage controller circuitry configured to randomly select, for at least some of the pulses in the plurality of pulses, a voltage within a predefined range.

23. The system of claim 15, wherein the variable voltage controller circuitry configured to select, for at least some of the pulses in the plurality of pulses, a stepped-up voltage level within a predefined range.

24. The system of claim 15, wherein the variable voltage controller circuitry configured to provide a user to select, for at least some of the pulses in the plurality of pulses, a voltage within a predefined range.

25. The system of claim 15, wherein the variable voltage controller circuitry configured to select, for at least some of the pulses in the plurality of pulses, a voltage within a predefined range based on a specified pest target.

26. The system of claim 15, further comprising: communications circuitry to exchange commands and data with a remote interface system.

27. The system of claim 15, further comprising power controller circuitry to control a power state of the pulse generator circuitry, the variable frequency controller circuitry, and the variable voltage controller circuitry.

28. The system of claim 15, further comprising:
one or more sensors selected from the group of an ambient light sensor to detect daylight, an image sensor to generate a still or video image, and/or a motion sensor to detect the presence of a pest based on motion; and
sensor interface circuitry to receive sensor data from the one or more sensors; wherein the pulse generator circuitry to control generation of the plurality of pulses based on, at least in part, the sensor data.
